(19) United States
(12) Patent Application Publication
(10) Pub. No.: US 2019/0310870 A1
(43) Pub. Date: Oct. 10, 2019

(54) VIRTUAL NETWORK FUNCTION INDICATOR SELECTION

(71) Applicant: NOKIA SOLUTIONS AND NETWORKS OY, Espoo (FI)

(72) Inventors: Gyula BODOG, Budapest (HU); Anatoly ANDRIANOV, Schaumburg, IL (US); Mehmet ERSUE, Munich (DE)

(21) Appl. No.: 16/317,364

(22) PCT Filed: Jul. 13, 2016
(86) PCT No.: PCT/US16/42051

§ 371 Date: Jan. 11, 2019

(51) Int. Cl. G06F 9/455

(52) U.S. Cl. CPC G06F 9/455

(57) ABSTRACT

Various communication systems may benefit from the appropriate selection of monitored parameters. For example, certain wireless communication systems may benefit from virtual network function indicator selection mechanisms that can be applied by a virtual network function manager. A method can include preparing an indicator declaration for an indicator value of a virtualized network function descriptor. The method can also include providing, in the indicator declaration, an indication of importance of the indicator value.

### BACKGROUND

### Field

Various communication systems may benefit from the appropriate selection of monitored parameters. For example, certain wireless communication systems may benefit from virtual network function indicator selection mechanisms that can be applied by a virtual network function manager.

### Description of the Related Art

In network function virtualization (NFV), an indicator interface has been defined between the virtual network function (VNF) and VNF manager (VNFM) or between the element manager (EM) and the VNFM. The indicators are declared in the VNF descriptor (VNFD) of each VNF with potential values of the indicators. These indicators and their values can be used for a scale algorithm running in the VNFM. However, the indicator may not be restricted only for scaling, but it can also be used for any other purposes as well. The indicator can provide information about the application status to the VNFM.

VNF indicators are declared in VNFD. The amount of exposed VNF indicators and their possible values are up to each VNF vendor's decision. There may be certain complex VNF types, requiring several indicators with several values to be declared in the VNFD. Some of the indicators could be providing very important information about the VNF health status, while other indicator may be used only for verification/coordination of a specific algorithm.

One generic VNFM is supposed to be able to manage multiple VNFs: multiple instances from multiple vendors. If each VNF exposes lots of indicators, the large number of indicators may overload the VNFM. Therefore, the VNFM may need to select what indicators it can subscribe to, instead of subscribing to all indicators declared by the VNF vendor in the VNFD. Selection of the specific subset of available indicators for subscription may require additional knowledge. Conventionally two options are available to a generic VNFM.

According to a first option, the VNFM subscribes to all the indicators. In this case the scale algorithm implemented as rule or as a script can fully utilize the information received in the indicatorValueChange notifications. If there are several VNFs with lots of indicators, indicator notifications processing may overload the VNFM.

According to a second option, the VNFM selects only an arbitrary subset of indicators and only the selected ones are used for the scale algorithm. If there is no knowledge as to which indicators are important or mandatory for a particular scale algorithm, the scale functionality may not work properly or not work at all.

Conventionally, VNF indicators are not prioritized. They are just declared in the VNFD. The VNFM uses the information that is available in the VNFD. If no priority of the indicator is present in the VNFD, the VNFM has no information as to which indicator is important and which is not. Thus, the VNFM may be unable to select the appropriate indicators to sub scribe to.

FIG. 1 illustrates a conventional VNF indicator declaration. FIG. 1 is table 7.1.10.3-1 in ETSI NFV GS IFA011. As shown in FIG. 1, there are five attributes: ID, name, indicator value, source, and action.

The identifier (ID) attribute is a unique identifier. The name attribute is a human readable name of the indicator. The indicator value attribute defines the allowed value of the given indicator.

The source attribute describes the source of the indicator. Possible values of the source can be VNF, EM, or both. The source attribute tells the consumer where to send the subscription request.

The action attribute defines an action that is associated to a particular indicator value. For example, the string in this attribute can be a link to a script or a set of rules.

### SUMMARY

According to a first embodiment, a method can include preparing an indicator declaration for an indicator value of a virtualized network function descriptor. The method can also include providing, in the indicator declaration, an indication of importance of the indicator value. The indication of importance can be, for example, a priority value or information regarding whether the indicator value is necessary for a particular algorithm or set of algorithms.

According to a second embodiment, a method can include receiving an indicator declaration for an indicator value of a virtualized network function descriptor. The method can also include obtaining, from the indicator declaration, an indication of importance of the indicator value. The indication of importance can be, for example, a priority value or information regarding whether the indicator value is necessary for a particular algorithm or set of algorithms.

According to third and fourth embodiments, an apparatus can include means for performing the method according to the first and second embodiments respectively, in any of their variants.

According to fifth and sixth embodiments, an apparatus can include at least one processor and at least one memory and computer program code. The at least one memory and the computer program code can be configured to, with the at least one processor, cause the apparatus at least to perform the method according to the first and second embodiments respectively, in any of their variants.

According to seventh and eighth embodiments, a computer program product may encode instructions for performing a process including the method according to the first and second embodiments respectively, in any of their variants.

According to ninth and tenth embodiments, a non-transitory computer readable medium may encode instructions that, when executed in hardware, perform a process including the method according to the first and second embodiments respectively, in any of their variants.

### BRIEF DESCRIPTION OF THE DRAWINGS

For proper understanding of the invention, reference should be made to the accompanying drawings, wherein:

FIG. 1 illustrates a conventional VNF indicator declaration.

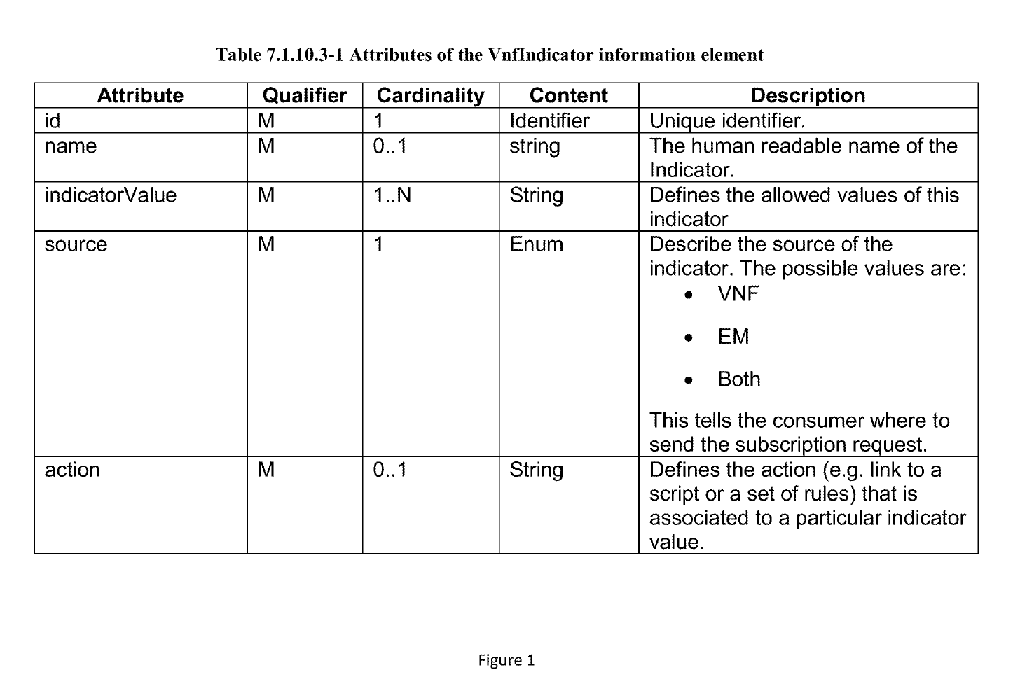

FIG. 2 illustrates the inclusion of an indicator priority attribute, according to certain embodiments.

FIG. 3 illustrates a flow chart involving the use a VNF indicator indicatorPriority attribute, according to certain embodiments.

FIG. 4 illustrates the inclusion of an associated algorithm attribute, according to certain embodiments.

FIG. 5 illustrates a flow chart involving the use a VNF indicator associatedAlgorithm attribute, according to certain embodiments.

FIG. 6 illustrates a method according to certain embodiments.

FIG. 7 illustrates a system according to certain embodiments.

### DETAILED DESCRIPTION

Certain embodiments provide enhancements to VNF indicator declaration in the VNFD. Certain embodiments can add priority values among the indicator declaration in the VNFD. These can be used as hints for a generic VNFM implementation. For example, these priority values can provide information about what is important for a particular VNF implementation.

Likewise, certain embodiments can add information about which specific VNF indicators are necessary for a particular algorithm. The particular algorithm may be, for example, scaling or healing.

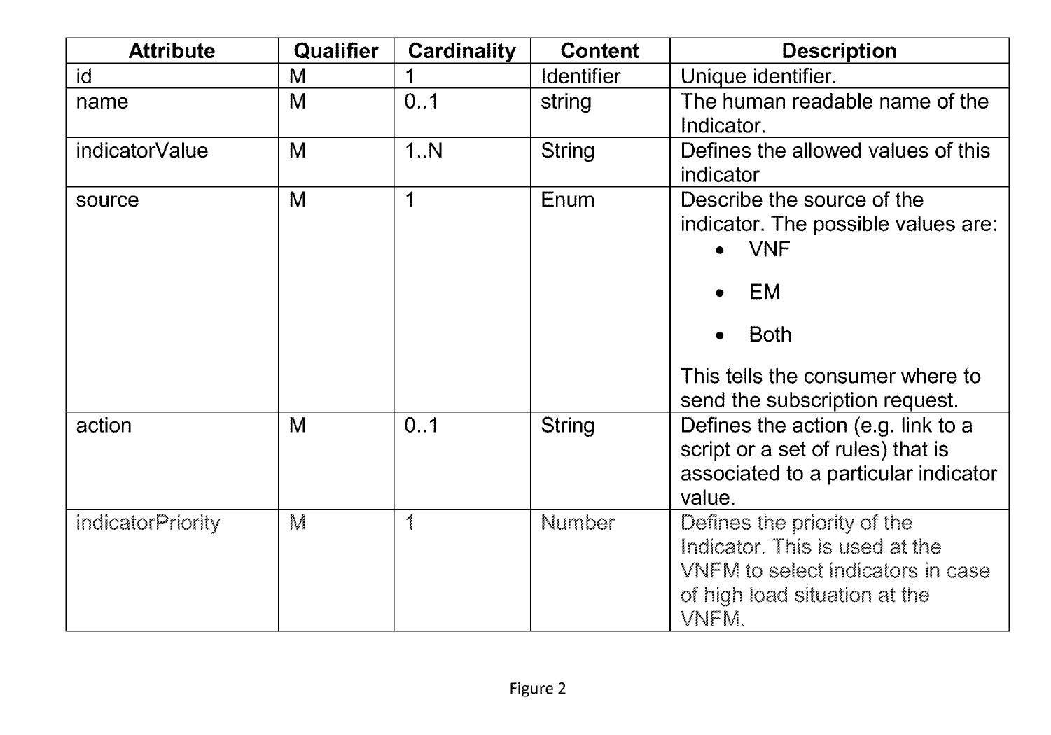

FIG. 2 illustrates the inclusion of an indicator priority attribute, according to certain embodiments. FIG. 2 can be seen as an enhancement of the VNF indicator declaration in ETSI NFV GS IFA011, with the enhancement including a new attribute.

As shown in FIG. 2, an indicator priority attribute can be a number. The number can define the priority of the indicator. The indicator priority number can be used at the VNFM to selector indicators in case of a high load situation at the VNFM.

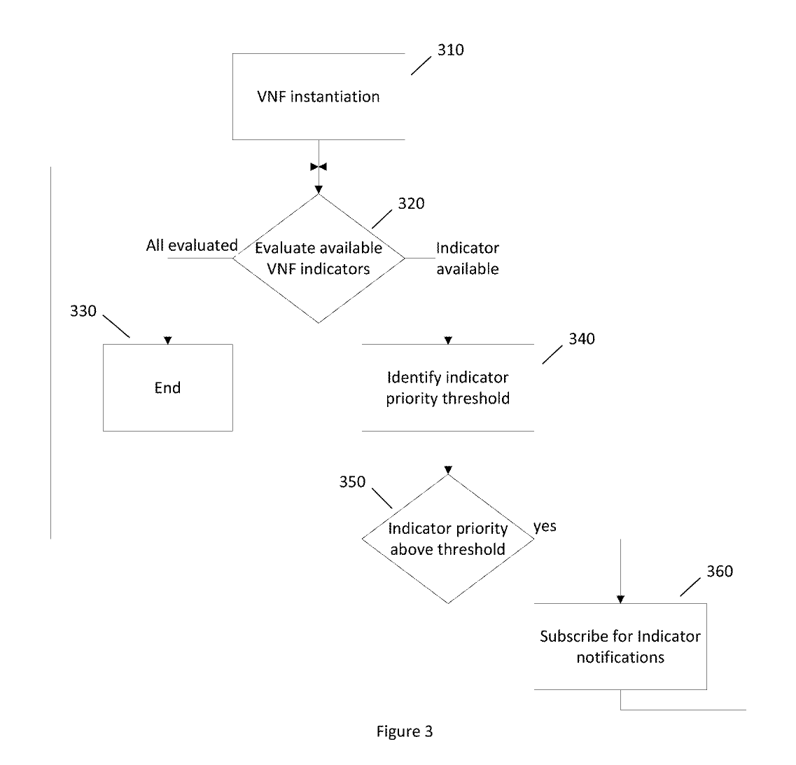

FIG. 3 illustrates a flow chart involving the use a VNF indicator indicatorPriority attribute, according to certain embodiments. As shown in FIG. 3, at 310, a VNF can be instantiated. Then, at 320, available VNF indicators can be evaluated. Once all the indicators are evaluated the flow can end at 330.

If there is an available indicator, than at 340, an identity priority threshold can be identified. At 350, a determination can be made as to whether the indicator priority is above a threshold. If the indicator priority is not above the threshold, the process may simply proceed to considering a different available indicator at 320. Otherwise, the process can include, at 360, subscribing for indicator notifications. Then, the process can proceed to consider a different available indicator at 320.

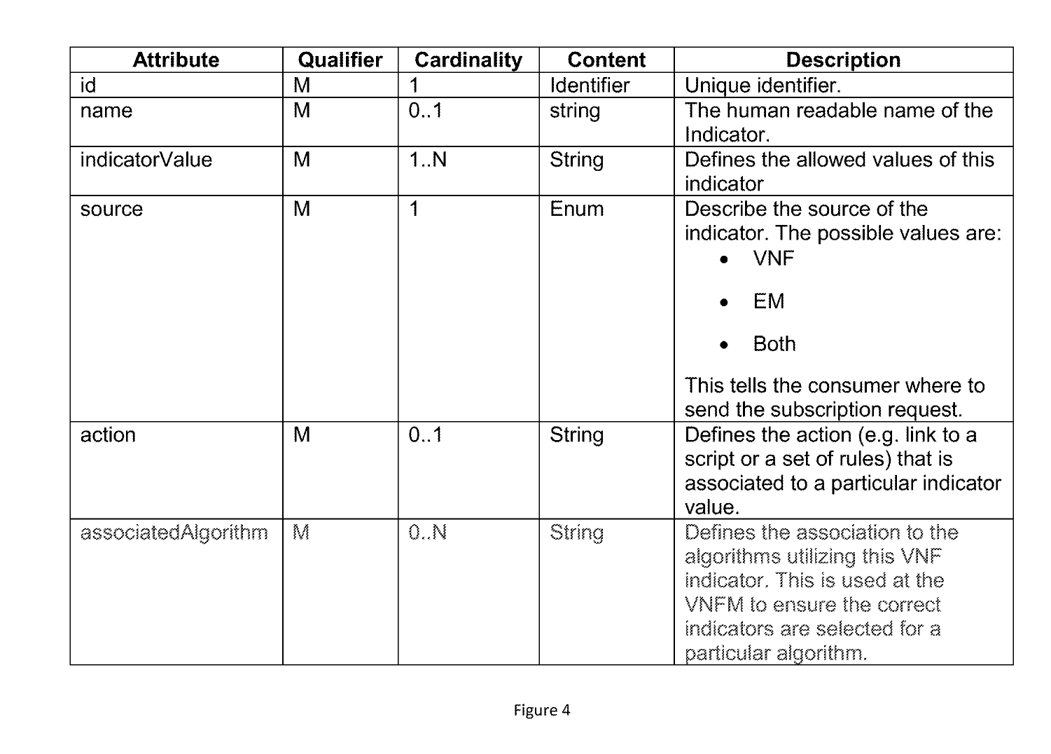

FIG. 4 illustrates the inclusion of an associated algorithm attribute, according to certain embodiments. As with FIG. 2, FIG. 4 can be seen as an enhancement of the VNF indicator declaration in ETSI NFV GS IFA011, with the enhancement including a new attribute.

As shown in FIG. 4, an associated algorithm attribute can be a string. String is just one option given as example. The attribute could also be an algorithm identifier, Lifecycle Management Operation identifier or a category identifier. The string or other identifier can define an association to the algorithm or algorithms using this VNF indicator. This information regarding association can be used at the VNFM to ensure that the correct indicators are selected for a particular algorithm. What is referred to herein as an algorithm can include, among other things, a lifecycle management (LCM) operation, or a category that this indicator belongs to. In the case of an LCM operation, the indicator can be associated with LCM operations that rely on it. In the case of categories, the category can be fault management (FM), performance management (PM), or LCM, for example.

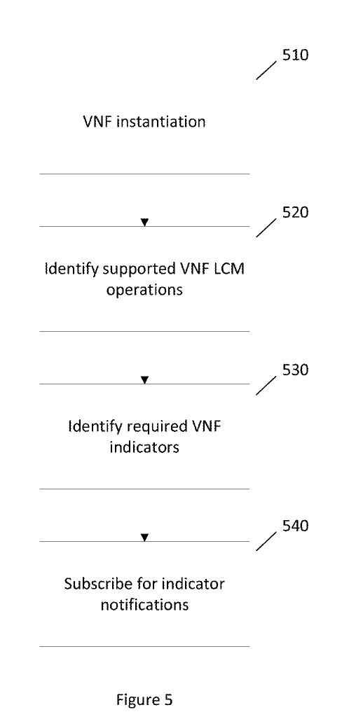

FIG. 5 illustrates a flow chart involving the use a VNF indicator associatedAlgorithm attribute, according to certain embodiments. As shown in FIG. 5, at 510, a VNF can be instantiated. Then, at 520, supported VNF LCM operations can be identified. Next, at 530, required VNF indicators can be identified. Finally, at 540, there can be subscription for indicator notifications for those indicators identified as required.

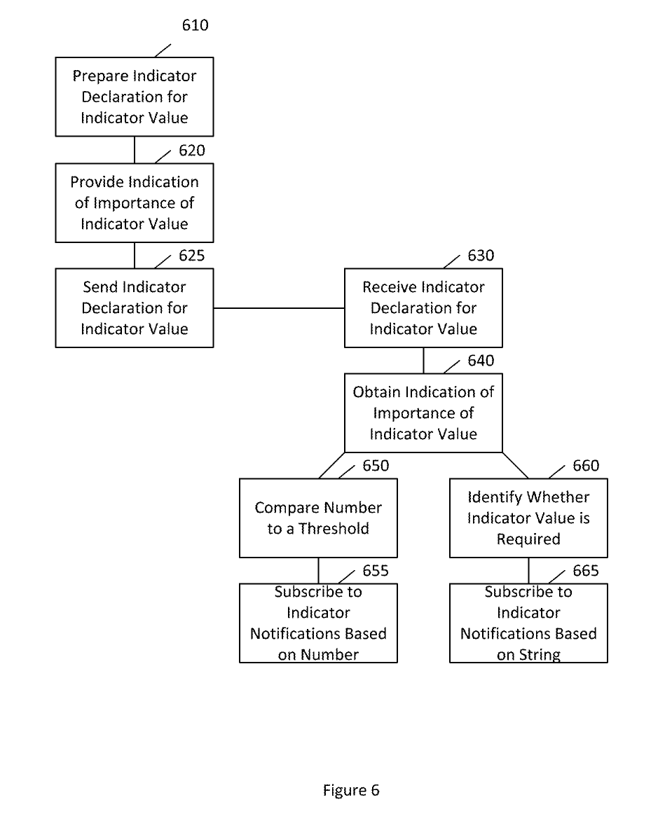

FIG. 6 illustrates a method according to certain embodiments. The method can include, at 610, preparing an indicator declaration for an indicator value of a virtualized network function descriptor. The method can also include, at 620, providing, in the indicator declaration, an indication of importance of the indicator value.

The indication of importance can include a priority value. The indication of importance can include information regarding whether the indicator value is necessary for a particular algorithm.

The indication of importance can be or include a number. This can be a number that is to be compared to a threshold. For example, the number can be on a range of 0 to 8 or 1 to 10. The threshold may depend on congestion in the NFVM, for example.

The indication of importance can be or include a string. This feature can be used alone or combination with the number. The string can indicate an associated algorithm or set of algorithms for which the indicator value is required.

The method can also include, at 630, receiving an indicator declaration for an indicator value of a virtualized network function descriptor. This can be sent at 625. The method can further include, at 640, obtaining, from the indicator declaration, an indication of importance of the indicator value.

As mentioned above, the indication of importance can be or include a priority value or information regarding whether indicator value is necessary for a particular algorithm. Moreover, the indication of importance can be a number or a string.

The method can further include, at 650, comparing the number or other indication of importance to a threshold. In the case of a non-numeric threshold, for example, the threshold may be set to include only mandatory or required indicator values, or to include both those indicator values and also indicator values that are recommended or optional. The threshold can optionally be set even lower, so that if the indicator value is merely possibly relevant to, for example, a particular algorithm or set of algorithms, it is included. The method can additionally include, at 655, subscribing to corresponding indicator notifications when the number exceeds the threshold. This process can be similar to the process set forth in FIG. 3.

As shown in FIG. 6, the method can also include, at 660, identifying whether the indicator value is required based on the string. Moreover, the method can include, at 665, subscribing for indicator notifications when it is identified that the indicator value is required. This process can be similar to the process set forth in FIG. 5.

The evaluation of indicator priority and evaluation of indicator association to an algorithm or set of algorithms may be non-exclusive. Consequently, these approaches may be combined as two ways of evaluating the importance of the indicator. For example, for a particular algorithm the indicators may be prioritized. Additionally, the priority levels may not necessarily be expressed as a number, but may still be evaluated against a threshold. For example, the priority levels per algorithm could be required/mandatory and recommended/optional. The indicator selection can then become identifying an algorithm/operation to be supported and, based on the VNFM load level, selecting a (sub)set of indicators that are required and/or recommended for this algorithm/operation. This can be a combination of FIGS. 3 and 5, in which steps 520 and 530 are executed within step 320.

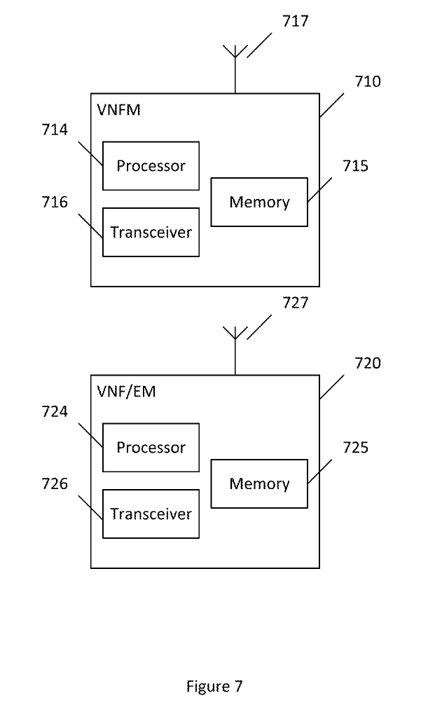

FIG. 7 illustrates a system according to certain embodiments of the invention. It should be understood that each block of the flowchart of FIGS. 3, 5, and 6 may be implemented by various means or their combinations, such as hardware, software, firmware, one or more processors and/or circuitry. In one embodiment, a system may include several devices, such as, for example, VNFM 710 and VNF or EM 720. The system may include more than one VNF/EM 720 and more than one VNFM 710, although only one of each is shown for the purposes of illustration.

Each of these devices may include at least one processor or control unit or module, respectively indicated as 714 and 724. At least one memory may be provided in each device, and indicated as 715 and 725, respectively. The memory may include computer program instructions or computer code contained therein, for example for carrying out the embodiments described above. One or more transceiver 716 and 726 may be provided, and each device may also include an antenna, respectively illustrated as 717 and 727. Although only one antenna each is shown, many antennas and multiple antenna elements may be provided to each of the devices. Other configurations of these devices, for example, may be provided. For example, VNFM 710 and VNF/EM 720 may be additionally or solely configured for wired communication, and in such a case antennas 717 and 727 may illustrate any form of communication hardware, without being limited to merely an antenna.

Transceivers 716 and 726 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is provided as software that can run on a server.

In an exemplifying embodiment, an apparatus, such as a node or server, may include means for carrying out embodiments described above in relation to FIG. 3, 5, or 6.

Processors 714 and 724 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. Additionally, the processors may be implemented as a pool of processors in a local configuration, in a cloud configuration, or in a combination thereof.

For firmware or software, the implementation may include modules or units of at least one chip set (e.g., procedures, functions, and so on). Memories 715 and 725 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as VNFM 710 and/or VNF/EM 720, to perform any of the processes described above (see, for example, FIGS. 3, 5, and 6). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 7 illustrates a system including a VNFM 710 and a VNF/EM 720, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

The entities such as EM, VNF, and VNFM can be considered as functional blocks that may be combined in an actual product or device. For example, an EM and a VNFM may be combined into one product and may be implemented on a single device, such as any of the devices illustrated in FIG. 7.

The functions may also be implemented using virtualization. So, any of the functional blocks described here, such as VNFM or EM, may be implemented using a virtual machine or virtualization container. A virtual machine or virtualization container may ultimately run on a variety of possible computing platforms.

Networks may utilize network functions virtualization which can refer to a network architecture concept that involves virtualizing network node functions into “building blocks” or entities that may be operationally connected or linked together to provide services. A virtualized network function may include one or more virtual machines running computer program codes using standard or general type servers instead of customized hardware. Cloud computing or data storage may also be utilized. In radio communications this may mean node operations can be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### LIST OF ABBREVIATIONS

VNFM—Virtualized Network Function Manager

NFV—Network Function Virtualization

VNF—Virtualized Network Function

VNFD—Virtualized Network Function Descriptor

1. A method, comprising:
preparing an indicator declaration for an indicator value of a virtualized network function descriptor; and
providing, in the indicator declaration, an indication of importance of the indicator value.

2. The method of claim 1, wherein the indication of importance comprises a priority value.

3. The method of claim 1, wherein the indication of importance comprises information regarding whether the indicator value is necessary for a particular algorithm.

4. The method of claim 1, wherein the indication of importance comprises a number.

5. The method of claim 1, wherein the indication of importance is configured to be compared to a threshold.

6. The method of claim 1, wherein the indication of importance comprises a string.

7. A method, comprising:
receiving an indicator declaration for an indicator value of a virtualized network function descriptor; and
obtaining, from the indicator declaration, an indication of importance of the indicator value.

8. The method of claim 7, wherein the indication of importance comprises a priority value.

9. The method of claim 7, wherein the indication of importance comprises information regarding whether the indicator value is necessary for a particular algorithm.

10. The method of claim 7, wherein the indication of importance comprises a number.

11. The method of claim 7, further comprising:
comparing the indication of importance to a threshold.

12. The method of claim 11, further comprising:
subscribing to corresponding indicator notifications when the number exceeds the threshold.

13. The method of claim 7, wherein the indication of importance comprises a string.

14. The method of claim 13, further comprising:
identifying whether the indicator value is required based on the string.

15. The method of claim 14, further comprising:
subscribing for indicator notifications when it is identified that the indicator value is required.

16. An apparatus, comprising:
at least one processor; and
at least one memory including computer program code,
wherein the at least one memory and the computer program code are configured to, with the at least one processor, cause the apparatus at least to perform
preparing an indicator declaration for an indicator value of a virtualized network function descriptor; and
providing, in the indicator declaration, an indication of importance of the indicator value.

17. (canceled)

18. A computer program product embodied on a non-transitory computer-readable medium, said computer-readable medium encoding instructions which, when executed in hardware, cause the hardware to perform the method according to claim 1.

19. (canceled)

20. An apparatus, comprising:
at least one processor; and
at least one memory including computer program code,
wherein the at least one memory and the computer program code are configured to, with the at least one processor, cause the apparatus at least to perform the method according to claim 7.

21. The apparatus according to claim 16, wherein the indication of importance comprises a priority value.

22. The apparatus according to claim 20, wherein the indication of importance comprises a priority value.
